(19) United States
(12) Patent Application Publication
(10) Pub. No.: US 2021/0309066 A1
(43) Pub. Date: Oct. 7, 2021

(54) SUSPENSION BUSHING AND SUSPENSION DEVICE

(71) Applicant: HONDA MOTOR CO., LTD., MINATO-KU, TOKYO (JP)

(72) Inventor: Tetsuji NISHIMURA, WAKO-SHI, SAITAMA-KEN (JP)

(21) Appl. No.: 17/261,119

(22) PCT Filed: Jun. 24, 2019
(86) PCT No.: PCT/JP2019/024860

§ 371 Date: Jan. 18, 2021

(30) Foreign Application Priority Data
Jul. 20, 2018 (JP) 2018-136343

(51) Int. Cl. B60G 21/05; F16F 1/38; B60G 7/02

(52) U.S. Cl. CPC B60G 21/052; F16F 1/38; B60G 7/02; B60G 2204/4104; B60G 2200/21; B60G 2206/20; B60G 2202/14

(57) ABSTRACT

Provided are a suspension bushing and a suspension device with which maneuvering stability can be improved without adversely affecting ride quality. Protrusions are formed on the outer circumferential surface of an inner tube, and slits are formed on the inner circumferential surface of an outer tube. The protrusions are arranged in the slits and have a tapered shape in which their width in a direction parallel to an axial line decreases as the distance from the axial line increases. The slits have a shape such that a gap in the direction parallel to the axial line decreases as the distance from the axial line increases.

### TECHNICAL FIELD

The present invention relates to a suspension bushing attached between a vehicle body and a suspension arm, and to a suspension device of torsion-beam type that uses this suspension bushing.

### BACKGROUND ART

Japanese Laid-Open Patent Publication No. 2010-054017 discloses an antivibration apparatus (antivibration bushing) used as a suspension bushing of an automobile. This antivibration bushing includes a space filled with rubber between an inner cylinder and an outer cylinder, and a protrusion on the outer circumference of the inner cylinder. When an external force in a direction orthogonal to the axis is applied to the antivibration bushing, the inner cylinder moves in the axis-orthogonal direction and the protrusion contacts the outer cylinder. In this way, the rigidity against the external force in the axis-orthogonal direction is increased.

### SUMMARY OF INVENTION

It is important to reduce the misalignment between the center of the outer cylinder and the center of the inner cylinder, in order to improve the vehicle maneuvering stability. However, the rubber between the inner cylinder and the outer cylinder deforms when the suspension bushing receives an external force. If this deformation of the rubber is significant, the vehicle maneuvering stability is reduced.

By reducing the volume of the rubber or by using rubber with a high level of hardness, it is possible to increase the rigidity of the rubber and reduce the misalignment between the center of the inner cylinder and the center of the outer cylinder. However, when the rigidity of the rubber is increased, there is a possibility that the vibration characteristics are worsened and the ride quality is adversely affected.

The present invention has been devised in order to solve this type of problem, and has the object of providing a suspension bushing and a suspension device that are capable of improving the maneuvering stability without adversely affecting the ride quality.

A first aspect of the present invention is:

a suspension bushing comprising an inner cylinder and an outer cylinder that are arranged on a same axial line, and an elastic member interposed between the inner cylinder and the outer cylinder, wherein

a convex portion is formed on an outer circumference of the inner cylinder,

a slit is formed in an inner circumference of the outer cylinder,

the convex portion is arranged inside the slit, and has a tapered shape in which a width in a direction parallel to the axial line decreases moving away from the axial line, and

the slit has a shape in which a space in the direction parallel to the axial line decreases moving away from the axial line.

A second aspect of the present invention is:

a suspension device of torsion-beam type that supports a right-left pair of trailing arms in a manner to be swingable relative to a vehicle body, by using a suspension bushing, wherein

the suspension bushing comprises:

an inner cylinder attached to the vehicle body;

an outer cylinder arranged on a same axial line as the inner cylinder and attached to the trailing arm; and

an elastic member interposed between the inner cylinder and the outer cylinder,

a convex portion is formed on an outer circumference of the inner cylinder,

a slit is formed in an inner circumference of the outer cylinder,

the convex portion is arranged inside the slit, and has a shape in which a length in a direction parallel to the axial line decreases moving away from the axial line, and

the slit has a shape in which a space in the direction parallel to the axial line decreases moving away from the axial line.

According to the present invention it is possible to improve the maneuvering stability without adversely affecting the ride quality.

### BRIEF DESCRIPTION OF DRAWINGS

FIG. 1 is a planar view of a suspension device according to an embodiment;

FIG. 2 is a perspective view of a suspension bushing according to the embodiment;

FIG. 3 is a cross-sectional view of the suspension bushing according to the embodiment;

FIG. 4 shows an inner circumference of an outer cylinder;

FIG. 5 shows the outer cylinder as seen from one axial-line direction (X direction);

FIG. 6 shows an outer circumference of an inner cylinder;

FIG. 7 shows the inner cylinder as seen from one axial-line direction (X direction);

FIG. 8 is a diagram for providing a description of the operation of the suspension bushing;

FIG. 9 is a cross-sectional view of a suspension bushing having an inner cylinder and an outer cylinder differing from those of FIG. 3; and

FIG. 10 is a cross-sectional view of a suspension bushing having an inner cylinder and an outer cylinder differing from those of FIG. 3.

### DESCRIPTION OF EMBODIMENTS

Preferred embodiments of a suspension bushing and a suspension device according to the present invention will be presented and described below with reference to the accompanying drawings.

### 1. Configuration of Suspension Device 10

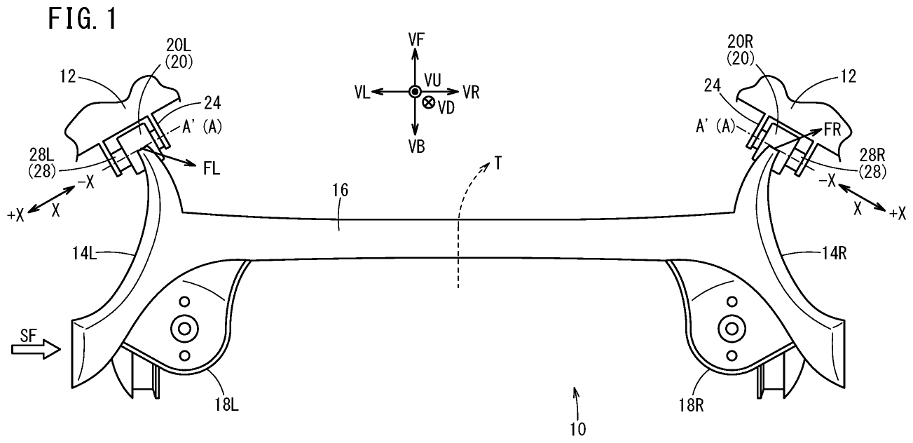

A suspension device 10 according to the present embodiment will be described using FIG. 1. In FIG. 1, VF (upward in the plane of the drawing) indicates the forward direction of a vehicle body 12 and VB (downward in the plane of the drawing) indicates the backward direction of the vehicle body 12. Furthermore, VR (rightward in the plane of the drawing) indicates the rightward direction of the vehicle body 12 and VL (leftward in the plane of the drawing) indicates the leftward direction of the vehicle body 12. Yet further, VU (toward the viewer from the plane of the drawing) indicates the upward direction of the vehicle body 12 and VD (away from the viewer from the plane of the drawing) indicates the downward direction of the vehicle body 12.

The suspension device 10 is a torsion-beam type, and includes a right-left pair of trailing arms 14R and 14L, a torsion beam 16 that connects the trailing arms 14R and 14L in the pair to each other, and a pair of spring receivers 18R and 18L that support the bottom ends of coil springs (not shown in the drawings).

Cylindrical portions 20R and 20L are formed on the forward-direction VF tips of the trailing arms 14R and 14L. The pair of cylindrical portions 20R and 20L are also referred to collectively below as cylindrical portions 20. An axial line A′ of the cylindrical portion 20R extends in a manner to progress in the backward direction VB of the vehicle body 12 as it progresses in the rightward direction VR of the vehicle body 12. An axial line A′ of the cylindrical portion 20L extends in a manner to progress in the backward direction VB of the vehicle body 12 as it progresses in the leftward direction VL of the vehicle body 12.

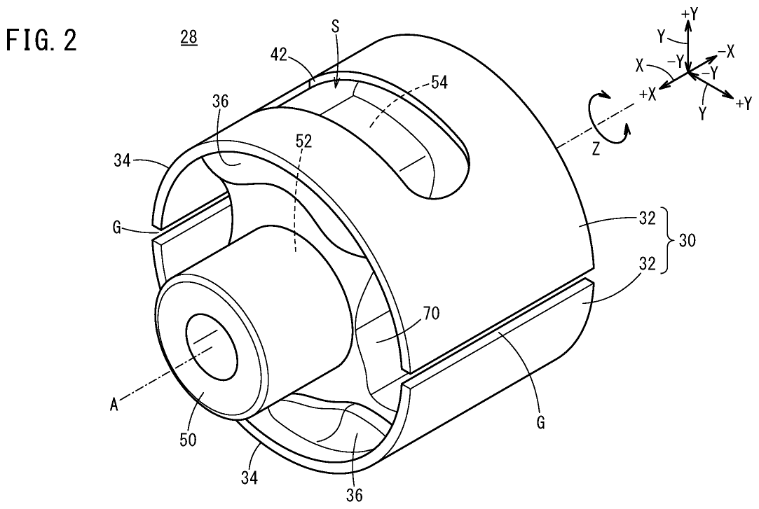

Suspension bushings 28R and 28L are press-fitted into the cylindrical portions 20R and 20L. The pair of suspension bushings 28R and 28L are also referred to collectively below as suspension bushings 28. Outer cylinders 30 (see FIG. 2 and the like) of the suspension bushings 28 are attached to the suspension device 10 side by having the suspension bushings 28 press-fitted into the cylindrical portions 20. On the other hand, inner cylinders 50 (see FIG. 2 and the like) of the suspension bushings 28 are attached to brackets 24, for example, on the vehicle body 12 side by bolts or the like.

In a state where the suspension bushing 28R has been press-fitted into the cylindrical portion 20R, an axial line A of the suspension bushing 28R extends from the inside to the outside in the vehicle width direction, that is, in a manner to progress in the backward direction VB of the vehicle body 12 as it progresses in the rightward direction VR of the vehicle body 12. The inclination angle of the axial line A of the suspension bushing 28R relative to the vehicle width direction (VR, VL) is approximately +27° to +33°, preferably approximately +30°, with the clockwise direction seen from the upward direction VU being the +direction. Similarly, in a state where the suspension bushing 28L has been press-fitted into the cylindrical portion 20L, an axial line A of the suspension bushing 28L extends from the inside to the outside in the vehicle width direction, that is, in a manner to progress in the backward direction VB of the vehicle body 12 as it progresses in the leftward direction VL of the vehicle body 12. The inclination angle of the axial line A of the suspension bushing 28L relative to the vehicle width direction (VR, VL) is approximately −27° to −33°, preferably approximately −30°, with the clockwise direction seen from the upward direction VU being the +direction. The inclination angles of the axial lines A of the suspension bushings 28R and 28L are not limited to those of the embodiment described above. For example, the inclination angles may be 0°.

### 2. Configuration of Suspension Bushings 28

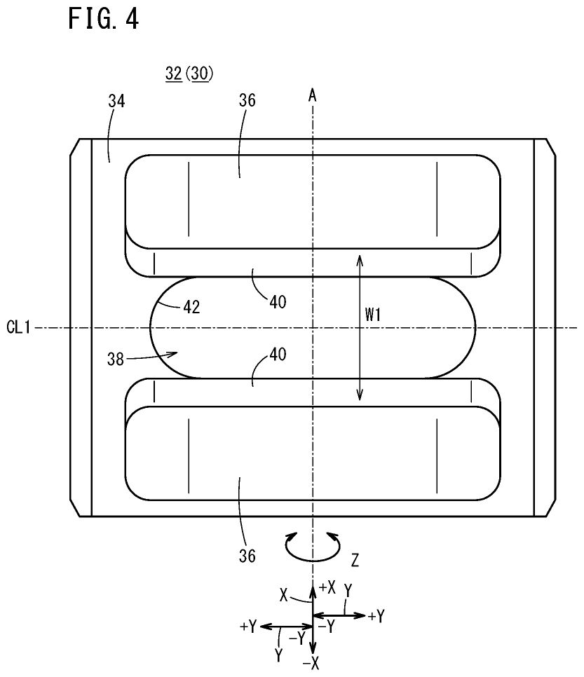

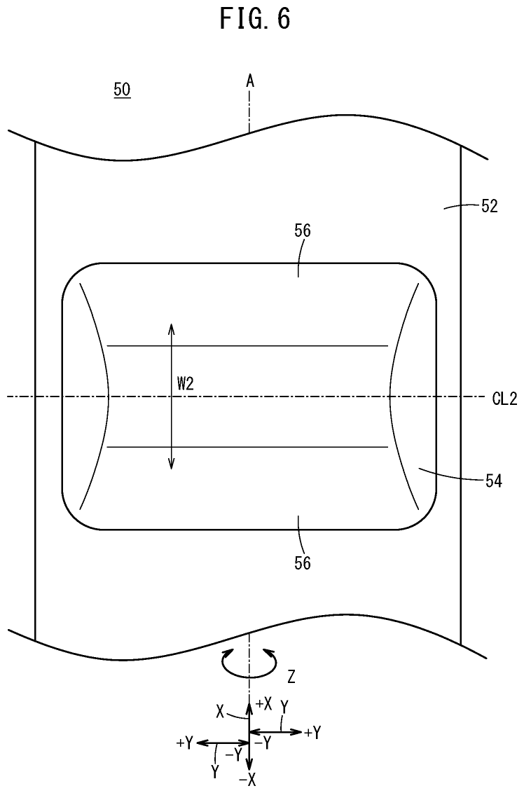

FIGS. 2 to 7 are used to describe the suspension bushing 28 according to the present embodiment. The surface of the inner cylinder 50 in FIG. 2, aside from the end surface on one side and the other side of the axial line A, is covered by an elastic member 70, so that the inner cylinder 50 cannot be seen from the outside. Therefore, in FIG. 2, each configurational element of the inner cylinder 50 covered by the elastic member 70 is given a reference numeral attached thereto by a dashed line.

The directions used in the following description are defined as shown below. The X direction is a direction parallel to the axial line A of the suspension bushing 28. Along this X direction, one direction is the +X direction and the other direction is the −X direction. For example, as shown in FIG. 1, in a state where the suspension bushings 28 are interposed between the vehicle body 12 and the trailing arms 14R and 14L, the direction along the X direction toward the outside of the vehicle is the +X direction and the direction along the X direction toward the center of the vehicle is the −X direction. Furthermore, the Y direction is the radial direction of the suspension bushings 28, the outer cylinders 30, and the inner cylinders 50. Along this Y direction, the direction away from the axial line A is the +Y direction and the direction toward the axial line A is the −Y direction. The Z direction is the circumferential direction of the suspension bushings 28, the outer cylinders 30, and the inner cylinders 50.

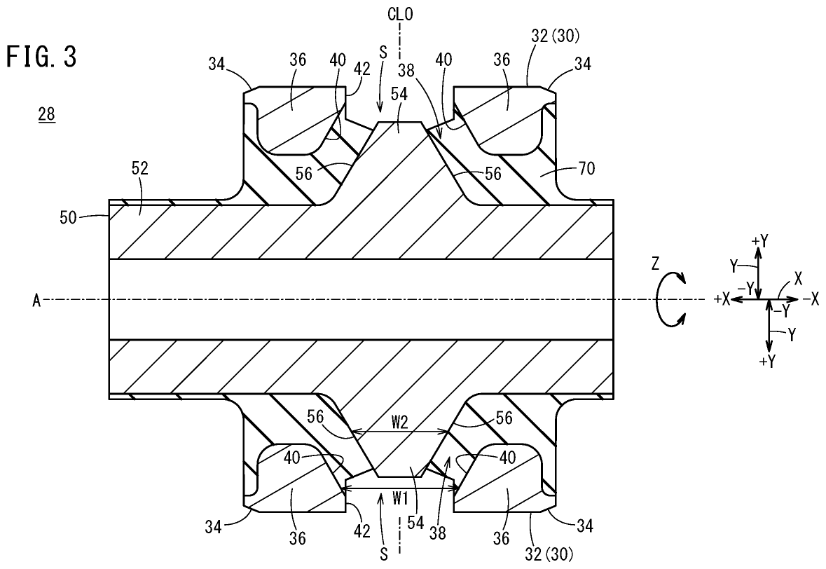

FIG. 3 is a cross-sectional view of the suspension bushing 28 according to the present embodiment, and shows a cross section parallel to the axial line A and passing through a guide 36, a convex portion 54, and the axial line A. As shown in FIGS. 2 and 3, the suspension bushing 28 includes the outer cylinder 30, the inner cylinder 50, and the elastic member 70. The outer cylinder 30 and the inner cylinder 50 are arranged on the same axial line A, and this is the axial line A of the suspension bushing 28. The inner cylinder 50 is supported by the elastic member 70 on the inside of the outer cylinder 30.

The outer cylinder 30 is formed by semi-cylindrical divided members 32 and 32 divided into two by a plane that is parallel to the axial line A and passes through the axial line A. The outer cylinder 30 may instead be divided into three or more pieces. The outer cylinder 30 is preferably divided uniformly, with the axial line A as the center. For example, in a case where the outer cylinder 30 is divided into three pieces, the outer cylinder 30 is preferably divided at intervals of 120° centered on the axial line A, and in a case where the outer cylinder 30 is divided into four pieces, the outer cylinder 30 is preferably divided at intervals of 90° centered on the axial line A.

When the suspension bushing 28 is in the finished product state, gaps G (FIG. 2) are formed at the locations where the outer cylinder 30 is divided. When the suspension bushing 28 is press-fitted into the cylindrical portion 20, the divided members 32 and 32 are pressed in the −Y direction by the cylindrical portion 20. As a result, the gaps G are closed. In this state, the divided members 32 and 32 are pressed in the +Y direction by the elastic member 70. As a result, the outer circumferential surfaces of the divided members 32 and 32 firmly contact the inner circumferential surface of the cylindrical portion 20. In contrast to this, in a state where the gaps G are closed, the elastic member 70 is pressed in the −Y direction by the divided members 32 and 32. The pressure generated in the −Y direction is split into an orthogonal-component force in a direction orthogonal to a guide wall surface 40 (FIG. 3), described further below, and a parallel-component force in a direction parallel to the guide wall surface 40. Among these forces, the orthogonal-component force becomes a compressive load on the elastic member 70, thereby improving the durability of the elastic member 70.

### 2.1. Configuration of Outer Cylinder 30 (Divided Members 32)

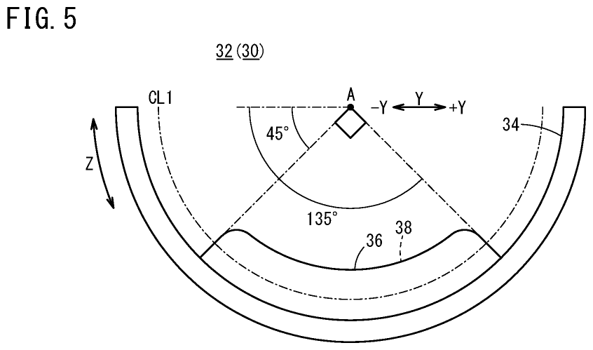

The following describes the divided member 32 forming the outer cylinder 30, using FIGS. 3 to 5. The divided member 32 is made of metal or resin, and is formed as a single body by a tube portion 34 that defines the outer circumferential shape and the guide 36 that protrudes in the −Y direction from the tube portion 34. As shown in FIG. 5, the guide 36 is formed in a range of approximately 90°, centered on the axial line A of the outer cylinder 30. This range may be suitably adjusted. The guide 36 is formed from a position of 45° to a position of 135°, centered on the axial line A. The thickness of the guide 36 in the Y direction is set to be an amount making it possible for the inner cylinder 50 and the elastic member 70 to be housed farther on the −Y-direction side than the guide 36. Furthermore, a plurality of the guides 36 may be provided along the X direction.

A slit 38 is formed in the guide 36. The slit 38 is formed such that a center line CL1 of the slit 38 in the longitudinal direction is arranged along the Z direction.

The slit 38 is formed by a pair of guide wall surfaces 40 and 40 positioned on the +X-direction and −X-direction sides. As shown in FIG. 3, in the cross section that passes through the guide 36 and the axial line A and is parallel to the axial line A, each guide wall surface 40 is inclined relative to the X direction and the Y direction. The inclination directions of the guide wall surfaces 40 and 40 in the pair are different from each other. Specifically, the pair of guide wall surfaces 40 and 40 are inclined such that a space W1 of the slit 38 becomes narrower moving in the +Y direction. The cross-sectional shape of the guide wall surface 40 positioned on the +X-direction side and the cross-sectional shape of the guide wall surface 40 positioned on the −X-direction side have line symmetry, with a center line CL0 parallel to the Y direction as an axis.

In other words, the slit 38 has a tapered shape in which the space W1 in the X direction decreases in both the +X direction and the −X direction moving away from the axial line A. As shown in FIG. 3, in the cross section that passes through the guide 36 and the axial line A and is parallel to the axial line A, each guide wall surface 40 has a linear shape. That is, the rate (decrease rate) at which the space W1 decreases moving away from the axial line A is constant, regardless of the distance from the axial line A.

A hole 42, which penetrates through the outer circumferential surface side of the divided members 32 and extends in the Z direction, is formed in the floor portion of the slit 38.

### 2.2. Configuration of Inner Cylinder 50

The inner cylinder 50 will be described using FIGS. 3, 6, and 7. The inner cylinder 50 is made of metal or resin, and is formed as a single body by a tube portion 52 that defines the outer circumferential shape and two convex portions 54 and 54 that protrude in the +Y direction from the tube portion 52. The number of convex portions 54 may instead be three or more. The plurality of convex portions 54 are arranged along the Z direction, centered on the axial line A. The plurality of convex portions 54 are preferably arranged at uniform intervals, but do not need to be arranged at uniform intervals. Furthermore, the plurality of convex portions 54 may be provided along the X direction.

The convex portions 54 are formed such that a center line CL2 of each convex portion 54 in the longitudinal direction is arranged along the Z direction, in the same manner as the slit 38 of the outer cylinder 30.

Each convex portion 54 includes a pair of convex portion wall surfaces 56 and 56 positioned on the +X-direction side and the −X-direction side. As shown in FIG. 3, in the cross section that passes through the convex portions 54 and the axial line A and is parallel to the axial line A, the convex portion wall surfaces 56 are inclined relative to the X direction and the Y direction. The inclination directions of the convex portion wall surfaces 56 and 56 in the pair are different from each other. Specifically, the pair of convex portion wall surfaces 56 and 56 are inclined such that a width W2 of the convex portion 54 becomes narrower progressing in the +Y direction. In the present embodiment, the convex portion wall surface 56 positioned on the +X-direction side and the convex portion wall surface 56 positioned on the −X-direction side have line symmetry, with the center line CL0 parallel to the Y direction as an axis, but do not need to have line symmetry.

In other words, the convex portion 54 has a tapered shape in which the width W2 in the X direction decreases in both the +X direction and the −X direction moving away from the axial line A. As shown in FIG. 3, in the cross section that passes through the convex portion 54 and the axial line A and is parallel to the axial line A, each convex portion wall surface 56 has a linear shape. That is, the rate (decrease rate) at which the width W2 decreases moving away from the axial line A is constant, regardless of the distance from the axial line A.

### 2.3. Configuration of Elastic Member 70

As shown in FIG. 3, the elastic member 70 is interposed between the outer cylinder 30 and the inner cylinder 50, on the inner circumference side of the outer cylinder 30 and the outer circumference side of the inner cylinder 50. The elastic member 70 is a member that elastically deforms, such as rubber, for example. The elastic member 70 made of rubber is formed in the following manner. First, a cavity having a prescribed shape is formed between the outer cylinder 30 and the inner cylinder 50 using a mold. Then, a molten unvulcanized compounded rubber (rubber compound) is pressure-injected into the cavity. The rubber is vulcanized and bonded to the outer cylinder 30 and the inner cylinder 50. The ease of rotation of the inner cylinder 50 relative to the outer cylinder 30 changes according to the shape of the rubber and the locations filled with the rubber. Therefore, the shape and filling locations of the rubber are set appropriately. Here, the rubber is vulcanized and bonded to a portion of the inner circumferential surface of the outer cylinder 30 (including the surface of the guide 36 but not including the vicinity of the gap G) and the entire outer circumferential surface of the inner cylinder 50 (including the surfaces of the convex portions 54).

As shown in FIG. 3, in the suspension bushing 28 in the final product state, the convex portions 54 are arranged in the slits 38. In this state, the convex portion wall surfaces 56 and the guide wall surfaces 40 face each other. Furthermore, the elastic member 70 does not close the holes 42 of the outer cylinder 30. In other words, a space S that is not filled with the elastic member 70 is formed in a portion of the holes 42 and the slits 38.

### 3. Operation of Suspension Bushing 28

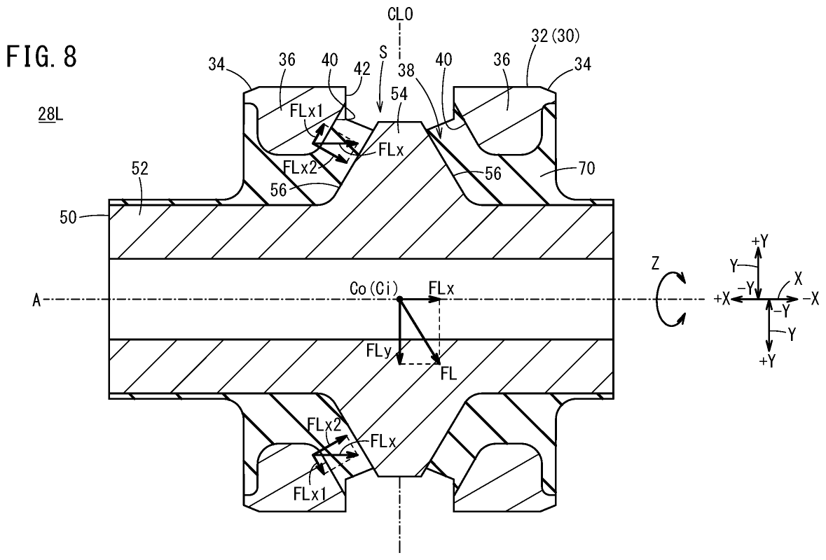

The operation of the suspension bushing 28 will be described using FIGS. 1 and 8. Here, as shown in FIG. 1, a case is envisioned in which the vehicle is steered in the rightward direction VR to turn in a T direction.

As shown in FIG. 1, when the vehicle turns in the T direction, the suspension device 10 receives a lateral force SF in the rightward direction VR from the vehicle wheels and attempts to rotate in the rightward direction VR. Then, a force FL in a rearward and diagonally rightward direction acts on the left-side suspension bushing 28L and a force FR in a forward and diagonally rightward direction acts on the right-side suspension bushing 28R. Since the operational principles are the same for the left and right suspension bushings 28, the following describes the operation of the left-side suspension bushing 28L and omits a description of the operation of the right-side suspension bushing 28R.

As shown in FIG. 8, in the left-side suspension bushing 28L, the force FL acts on the outer cylinder 30. The force FL can be thought of as being broken down into an X-direction component FLx and a Y-direction component FLy. When the component FLx acting on the outer cylinder 30 becomes large, misalignment in the X direction occurs between a center Co of the outer cylinder 30 and a center Ci of the inner cylinder 50. Furthermore, when the component FLy acting on the outer cylinder 30 becomes large, misalignment in the Y direction occurs between the center Co of the outer cylinder 30 and the center Ci of the inner cylinder 50. The misalignment in the Y direction has an effect on the turning operation of the vehicle.

The suspension bushing 28 operates to decrease the misalignment in the Y direction. This principle is thought of in the following manner. As described above, the guide wall surfaces 40 and the convex portion wall surfaces 56 have tapered shapes. Therefore, the X-direction component FLx acting on the guide wall surface 40 can be thought of as being broken down into a component FLx1 in a direction parallel to the guide wall surface 40 and a component FLx2 in a direction orthogonal to the guide wall surface 40. For example, in the suspension bushing 28L shown in FIG. 8, when the component FLx in the −X direction occurs, the guide wall surface 40 on the left side (+X-direction side) of the center line CL0 approaches the convex portion wall surface 56. At this time, the component FLx1 acts across the Z direction to move the guide wall surface 40 in the +Y direction. The component FLx2 acts to press the left-side (+X-direction-side) guide wall surface 40 against the elastic member 70.

If the center Co of the outer cylinder 30 is on the axial line A, the component FLx is uniform across the Z direction. On the other hand, if the center Co of the outer cylinder 30 is offset in the +Y direction from the axial line A, the component FLx1 generated at the guide wall surface 40 on the side in a direction opposite the direction of the offset becomes large, and a force returning this offset to the original state acts on the outer cylinder 30. In other words, the component FLx1 acts to hold the center Co of the outer cylinder 30 on the axial line A.

### 4. Modifications

Various modifications can be envisioned for the suspension bushings 28 and the suspension device 10 according to the embodiment described above.

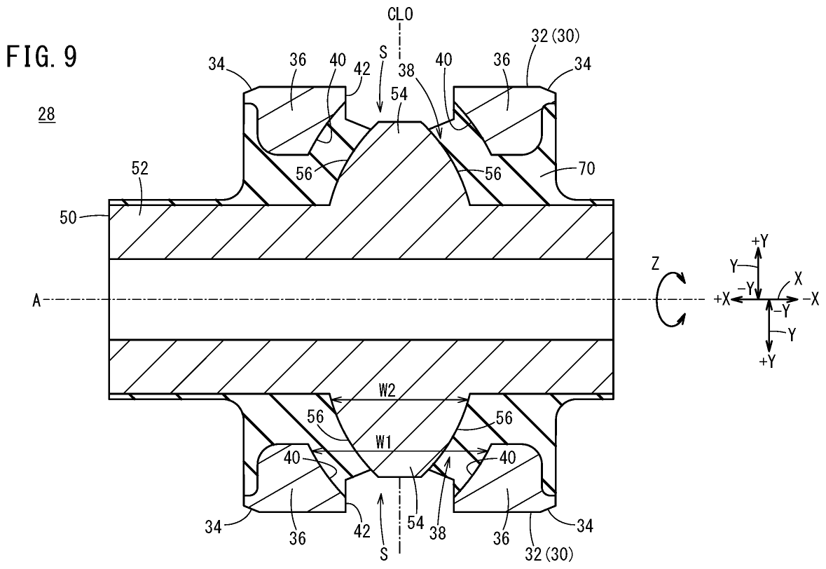

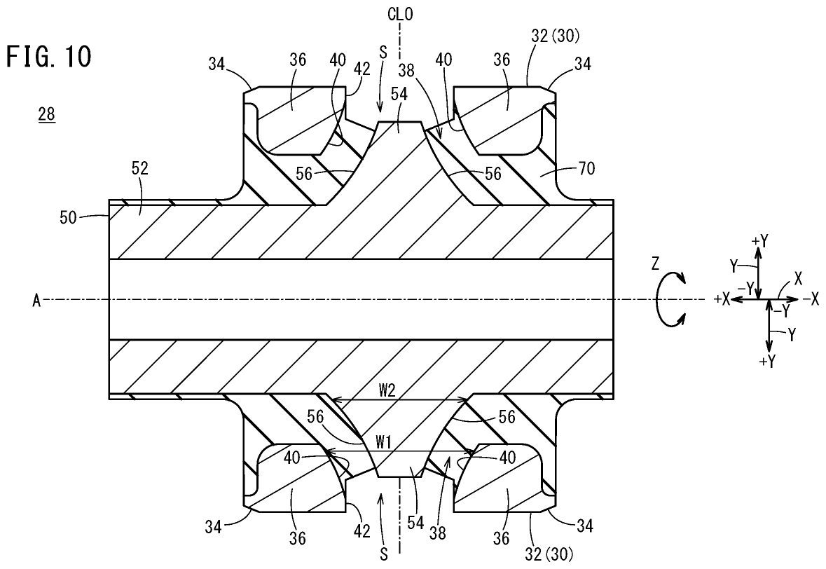

As shown in FIG. 3, in the suspension bushing 28 according to the embodiment described above, the guide wall surfaces 40 and the convex portion wall surfaces 56 have linear shapes in the cross section that passes through the guides 36, the convex portions 54, and the axial line A and is parallel to the axial line A. Instead, as shown in FIGS. 9 and 10, the guide wall surfaces 40 and the convex portion wall surfaces 56 may have curved shapes in the cross section that passes through the guides 36, the convex portions 54, and the axial line A and is parallel to the axial line A.

In the suspension bushing 28 shown in FIG. 9, each slit 38 has a shape in which the decrease rate of the space W1 increases moving away from the axial line A. In the case of this modification, in the cross section that passes through the convex portions 54 and the axial line A and is parallel to the axial line A, the curvature of the guide wall surface 40 may be constant (that is, an arc) regardless of the distance from the axial line A, or the curvature of the guide wall surface 40 may increase or decrease moving away from the axial line A.

Each convex portion 54 has a shape in which the decrease rate of the width W2 increases moving away from the axial line A. In the case of this modification, in the cross section that passes through the convex portions 54 and the axial line A and is parallel to the axial line A, the curvatures of the convex portion wall surfaces 56 may be constant (that is, an arc) regardless of the distance from the axial line A, or the curvatures of the convex portion wall surfaces 56 may increase or decrease moving away from the axial line A. The curvatures of the convex portion wall surfaces 56 and the curvatures of the guide wall surfaces 40 may be the same, or may be different.

If the inner cylinder 50 rotates in the Z direction relative to the outer cylinder 30 or the outer cylinder 30 rotates in the Z direction relative to the inner cylinder 50, the distortion amount of the elastic member 70 becomes greater farther from the axial line A. Therefore, it is preferable to increase the compression amount of the elastic member 70 that is far from the axial line A. According to the suspension bushing 28 shown in FIG. 9, the convex portion wall surfaces 56 and the guide wall surfaces 40 become closer to being parallel to the axial line A farther from the axial line A, and therefore the compression amount of the elastic member 70 in the state where the gaps G are closed becomes greater. As a result, there is less distortion of the elastic member 70.

In the suspension bushing 28 shown in FIG. 10, each slit 38 has a shape in which the decrease rate of the space W1 decreases moving away from the axial line A. In the case of this modification, in the cross section that passes through the convex portions 54 and the axial line A and is parallel to the axial line A, the curvature of the guide wall surface 40 may be constant (that is, an arc) regardless of the distance from the axial line A, or the curvature of the guide wall surface 40 may increase or decrease moving away from the axial line A.

Each convex portion 54 has a shape in which the decrease rate of the width W2 decreases moving away from the axial line A. In the case of this modification, in the cross section that passes through the convex portions 54 and the axial line A and is parallel to the axial line A, the curvatures of the convex portion wall surfaces 56 may be constant (that is, an arc) regardless of the distance from the axial line A, or the curvatures of the convex portion wall surfaces 56 may increase or decrease moving away from the axial line A. The curvatures of the convex portion wall surfaces 56 and the curvatures of the guide wall surfaces 40 are the same.

### 5. Technical Concepts and Effects Obtainable from Embodiments

A suspension bushing 28 includes an inner cylinder 50 and an outer cylinder 30 that are arranged on the same axial line A, and an elastic member 70 interposed between the inner cylinder 50 and the outer cylinder 30. A convex portion 54 is formed on the outer circumference of the inner cylinder 50, and a slit 38 is formed in the inner circumference of the outer cylinder 30. The convex portion 54 is arranged within the slit 38, and has a tapered shape in which the width W2 in a direction parallel to the axial line A decreases moving away from the axial line A. The slit 38 has a shape in which the space W1 in the direction parallel to the axial line A decreases moving away from the axial line A.

According to the above configuration, the convex portion 54 and the slit 38 have tapered shapes, due to which a component FLx1 of a component FLx, which is in an axial line direction (X direction) and acts on the outer cylinder 30, acts to hold the center Co of the outer cylinder 30 on the axial line A. Therefore, it is possible to reduce the misalignment between the center Co of the outer cylinder 30 and the center Ci of the inner cylinder 50, and it is possible to improve the maneuvering stability of the vehicle. Furthermore, there is no need to reduce the volume of the elastic member 70 and no need to use the elastic member 70 with a high degree of hardness, and therefore there is no adverse effect on the ride quality.

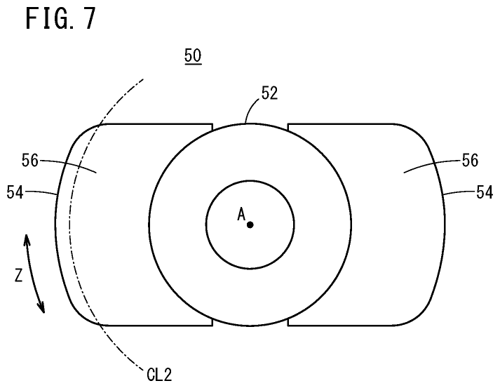

As shown in FIGS. 5 and 7, the convex portion 54 and the slit 38 are formed along the circumferential direction (Z direction), centered on the axial line A.

According to the above configuration, it is possible to increase the surface area of the convex portion wall surfaces 56 and the surface area of the guide wall surfaces 40, and to distribute the force applied to the elastic member 70 when the elastic member 70 is compressed by the convex portion wall surfaces 56 and the guide wall surfaces 40. Therefore, wear on the elastic member 70 can be suppressed.

As shown in FIG. 9, the convex portion 54 may have a shape in which the decrease rate of the width W2 increases moving away from the axial line A, and the slit 38 may have a shape in which the decrease rate of the space W1 increases moving away from the axial line A.

According to the above configuration, it is possible to realize more compression of the elastic member 70 arranged outward in the radial direction (+Y direction) using the convex portion wall surfaces 56 and the guide wall surfaces 40. As a result, wear on the elastic member 70 can be suppressed.

As shown in FIG. 3, the convex portion 54 may have a shape in which the decrease rate of the width W2 is constant regardless of the distance from the axial line A, and the slit 38 may have a shape in which the decrease rate of the space W1 is constant regardless of the distance from the axial line A.

According to the above configuration, it is possible to improve the maneuvering stability without adversely affecting the ride quality.

As shown in FIG. 10, the convex portion 54 may have a shape in which the decrease rate of the width W2 decreases moving away from the axial line A, and the slit 38 may have a shape in which the decrease rate of the space W1 decreases moving away from the axial line A.

According to the above configuration, it is possible to improve the maneuvering stability without adversely affecting the ride quality.

The suspension device 10 of torsion-beam type supports the right-left pair of trailing arms 14R and 14L in a manner to be swingable relative to the vehicle body 12, by using the suspension bushings 28R and 28L.

According to the above configuration, it is possible to improve the maneuvering stability without adversely affecting the ride quality.

The suspension bushing and the suspension device according to the present invention are not limited to the above-described embodiments, and it goes without saying that various configurations could be adopted therein without departing from the essence and gist of the present invention.

1. A suspension bushing comprising an inner cylinder and an outer cylinder that are arranged on a same axial line, and an elastic member interposed between the inner cylinder and the outer cylinder, wherein
a convex portion is formed on an outer circumference of the inner cylinder,
a slit is formed in an inner circumference of the outer cylinder,
the convex portion is arranged inside the slit, and has a tapered shape in which a width in a direction parallel to the axial line decreases moving away from the axial line, and
the slit has a shape in which a space in the direction parallel to the axial line decreases moving away from the axial line.

2. The suspension bushing according to claim 1, wherein
the convex portion and the slit are formed along a circumferential direction centered on the axial line.

3. The suspension bushing according to claim 1, wherein
the convex portion has a shape in which a decrease rate of the width increases moving away from the axial line, and
the slit has a shape in which a decrease rate of the space increases moving away from the axial line.

4. The suspension bushing according to claim 1, wherein,
the convex portion has a shape in which a decrease rate of the width is constant regardless of a distance from the axial line, and
the slit has a shape in which a decrease rate of the space is constant regardless of the distance from the axial line.

5. The suspension bushing according to claim 1, wherein
the convex portion has a shape in which a decrease rate of the width decreases moving away from the axial line, and
the slit has a shape in which a decrease rate of the space decreases moving away from the axial line.

6. A suspension device of torsion-beam type that supports a right-left pair of trailing arms in a manner to be swingable relative to a vehicle body, by using a suspension bushing, wherein
the suspension bushing comprises:
an inner cylinder attached to the vehicle body;
an outer cylinder arranged on a same axial line as the inner cylinder and attached to the trailing arm; and
an elastic member interposed between the inner cylinder and the outer cylinder,
a convex portion is formed on an outer circumference of the inner cylinder,
a slit is formed in an inner circumference of the outer cylinder,
the convex portion is arranged inside the slit, and has a shape in which a width in a direction parallel to the axial line decreases moving away from the axial line, and
the slit has a shape in which a space in the direction parallel to the axial line decreases moving away from the axial line.
